(19) United States
(12) Patent Application Publication
(10) Pub. No.: US 2024/0244515 A1
(43) Pub. Date: Jul. 18, 2024

(54) NETWORK COMMUNICATION METHOD AND APPARATUS, AND RELATED DEVICE

(71) Applicant: VIVO MOBILE COMMUNICATION CO., LTD., Guangdong (CN)

(72) Inventor: Lufeng HAN, Guangdong (CN)

(73) Assignee: VIVO MOBILE COMMUNICATION CO., LTD., Guangdong (CN)

(21) Appl. No.: 18/621,263

(22) Filed: Mar. 29, 2024

Related U.S. Application Data
(63) Continuation of application No. PCT/CN2022/120549, filed on Sep. 22, 2022.

(30) Foreign Application Priority Data
Sep. 29, 2021 (CN) 202111155120.5

(51) Int. Cl. H04W 48/18; H04W 8/22; H04W 84/04

(52) U.S. Cl. CPC H04W 48/18; H04W 8/22; H04W 84/042

(57) ABSTRACT

A network communication method and apparatus, and a related device. The network communication method in embodiments of this application includes: A first network element determines, based on state information, that a terminal is required to obtain a service on a higher priority network, where the state information reflects a service state of the terminal in a selected network, and a priority of the higher priority network is higher than a priority of the selected network; and the first network element sends, to the terminal, at least one of: first indication information and network information, where the first indication information is used to indicate the terminal to attempt to obtain the service on the higher priority network, and the network information is information about the higher priority network.

### CROSS-REFERENCE TO RELATED APPLICATIONS

This application is a continuation of International Application No. PCT/CN2022/120549 filed on Sep. 22, 2022, which claims priority to Chinese Patent Application No. 202111155120.5 filed on Sep. 29, 2021, which are incorporated herein by reference in their entireties.

### TECHNICAL FIELD

This application pertains to the field of communication technologies, and specifically relates to a network communication method and apparatus, and a related device.

### BACKGROUND

Currently, to obtain a service on a network, a terminal mainly selects a default network by using a default rule. In this way, the terminal cannot change the network dynamically. Consequently, the terminal may be registered in a poor network, and network performance of the terminal is poor.

### SUMMARY

According to a first aspect, a network communication method is provided, including:

A first network element determines, based on state information, that a terminal is required to obtain a service on a higher priority network, where the state information reflects a service state of the terminal in a selected network, and a priority of the higher priority network is higher than a priority of the selected network; and
the first network element sends, to the terminal, at least one of: first indication information and network information, where the first indication information is used to indicate the terminal to attempt to obtain the service on the higher priority network, and the network information is information about the higher priority network.

According to a second aspect, a network communication method is provided, including:

A terminal receives at least one of: first indication information and network information sent by a first network element, where the first indication information is used to indicate to obtain a service on a higher priority network, the network information is information about the higher priority network, and a priority of the higher priority network is higher than a priority of a selected network; and
the terminal attempts to obtain the service on the higher priority network based on at least one of: the first indication information and the network information.

According to a third aspect, a network communication method is provided, including:

A terminal receives second indication information sent by a first network element, where the second indication information is used to indicate no change of an OPLMN list stored in the terminal; and
the terminal performs, based on the second indication information, at least one of the following:
in a case that a UDM network element does not require to obtain an acknowledgement ACK from the terminal, skipping sending a registration complete message to an AMF network element, where a SOR transparent container of the registration complete message carries the ACK; and
after an N1 NAS signaling connection is released, attempting or skipping attempting to obtain a service on a higher priority PLMN.

According to a fourth aspect, a network communication apparatus is provided, including:
a determining module, configured to determine, based on state information, that a terminal is required to obtain a service on a higher priority network, where the state information reflects a service state of the terminal in a selected network, and a priority of the higher priority network is higher than a priority of the selected network; and
a sending module, configured to send, to the terminal, at least one of: first indication information and network information, where the first indication information is used to indicate the terminal to attempt to obtain the service on the higher priority network, and the network information is information about the higher priority network.

According to a fifth aspect, a network communication apparatus is provided, including:
a first receiving module, configured to receive at least one of: first indication information and network information sent by a first network element, where the first indication information is used to indicate to obtain a service on a higher priority network, the network information is information about the higher priority network, and a priority of the higher priority network is higher than a priority of a selected network; and
a first execution module, configured to attempt to obtain the service on the higher priority network based on at least one of: the first indication information and the network information.

According to a sixth aspect, a network communication apparatus is provided, including:
a second receiving module, configured to receive second indication information sent by a first network element, where the second indication information is used to indicate no change of an OPLMN list stored in the apparatus; and
a second execution module, configured to perform, based on the second indication information, at least one of the following:
in a case that a UDM network element does not require to obtain an acknowledgement ACK from the apparatus, skipping sending a registration complete message to an AMF network element, where a SOR transparent container of the registration complete message carries the ACK; and
after an N1 NAS signaling connection is released, attempting or skipping attempting to obtain a service on a higher priority PLMN.

According to a seventh aspect, a network element is provided, where the network element is a first network element, and includes a processor, a memory, and a program or an instruction that is stored in the memory and that can be run on the processor, and when the program or the instruction is executed by the processor, the steps of the network communication method according to the first aspect are implemented.

According to an eighth aspect, a network element is provided, including a processor and a communication interface. The processor is configured to: determine, based on state information, that a terminal is required to obtain a service on a higher priority network, where the state information reflects a service state of the terminal in a selected network, and a priority of the higher priority network is higher than a priority of the selected network; and
send, to the terminal, at least one of: first indication information and network information, where the first indication information is used to indicate the terminal to attempt to obtain the service on the higher priority network, and the network information is information about the higher priority network.

According to a ninth aspect, a terminal is provided. The terminal includes a processor, a memory, and a program or an instruction that is stored in the memory and that can be run on the processor, where when the program or the instruction is executed by the processor, the steps of the network communication method according to the second aspect or the third aspect are implemented.

According to a tenth aspect, a terminal is provided, including a processor and a communication interface. The processor is configured to receive at least one of: first indication information and network information sent by a first network element, where the first indication information is used to indicate to obtain a service on a higher priority network, the network information is information about the higher priority network, and a priority of the higher priority network is higher than a priority of a selected network; and
attempt to obtain the service on the higher priority network based on at least one of: the first indication information and the network information.

Alternatively, the processor is configured to: receive second indication information sent by a first network element, where the second indication information is used to indicate no change of an OPLMN list stored in the terminal; and
perform, based on the second indication information, at least one of the following:
in a case that a UDM network element does not require to obtain an acknowledgement ACK from the terminal, skipping sending a registration complete message to an AMF network element, where a SOR transparent container of the registration complete message carries the ACK; and
after an N1 NAS signaling connection is released, attempting or skipping attempting to obtain a service on a higher priority PLMN.

According to an eleventh aspect, a readable storage medium is provided. The readable storage medium stores a program or an instruction, and when the program or the instruction is executed by a processor, the steps of the network communication method according to the first aspect, the second aspect, or the third aspect are implemented.

According to a twelfth aspect, a chip is provided. The chip includes a processor and a communication interface, the communication interface is coupled to the processor, and the processor is configured to run a program or an instruction to implement the steps of the network communication method according to the first aspect, the second aspect, or the third aspect.

According to a thirteenth aspect, a computer program/program product is provided, where the computer program/program product is stored in a non-transient storage medium, and the program/program product is executed by at least one processor to implement the steps of the network communication method according to the first aspect, the second aspect, or the third aspect.

According to a fourteenth aspect, a communication device is provided, configured to implement the steps of the network communication method according to the first aspect, the second aspect, or the third aspect.

### BRIEF DESCRIPTION OF DRAWINGS

FIG. 1 is a first flowchart of a network communication method according to an embodiment of this application;

FIG. 2 is a second flowchart of a network communication method according to an embodiment of this application;

FIG. 3 is a third flowchart of a network communication method according to an embodiment of this application;

FIG. 4 is a fourth flowchart of a network communication method according to an embodiment of this application;

FIG. 5 is a fifth flowchart of a network communication method according to an embodiment of this application;

FIG. 6a is a first schematic diagram of a scenario of a network communication method according to an embodiment of this application;

FIG. 6b is a second schematic diagram of a scenario of a network communication method according to an embodiment of this application;

FIG. 6c is a third schematic diagram of a scenario of a network communication method according to an embodiment of this application;

FIG. 6d is a fourth schematic diagram of a scenario of a network communication method according to an embodiment of this application;

FIG. 6e is a fifth schematic diagram of a scenario of a network communication method according to an embodiment of this application;

FIG. 7 is a structural diagram of a network communication apparatus according to an embodiment of this application;

FIG. 8 is a structural diagram of another network communication apparatus according to an embodiment of this application;

FIG. 9 is a structural diagram of another network communication apparatus according to an embodiment of this application;

FIG. 10 is a structural diagram of a communication device according to an embodiment of this application; and

FIG. 11 is a structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that the technology described in the embodiments of this application is not limited to a long term evolution (LTE)/LTE-advanced (LTE-A) system, and may also be used in other wireless communication systems such as code division multiple access (CDMA), time division multiple access (TDMA), frequency division multiple access (FDMA), orthogonal frequency division multiple access (OFDMA), single-carrier frequency-division multiple access (SC-FDMA), and another system. The terms “system” and “network” in the embodiments of this application may be usually used interchangeably. The technologies described can be applied to both the systems and the radio technologies mentioned above as well as to other systems and radio technologies. The following descriptions describe a new radio (NR) system for illustrative purposes, and NR terms are used in most of the following descriptions, but these technologies may also be applied to an application other than an NR system application, for example, a 6th generation (6G) communication system.

A terminal in the embodiments of this application may also be referred to as a terminal device or user equipment (UE). The terminal may be a terminal side device such as a mobile phone, a tablet personal computer, a laptop computer (or referred to as a notebook computer), a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), or a smart home (a home device having a wireless communication function, such as a refrigerator, a television, a washing machine, or furniture). The wearable device includes: a smartwatch, a smart bracelet, a smart headphone, smart glasses, smart jewelry (a smart bangle, a smart bracelet, a smart ring, a smart necklace, a smart anklet, a smart ankle chain, and the like), a smart wristband, smart clothing, a game console, and the like. It should be noted that a specific type of the terminal is not limited in the embodiments of this application.

To better understand the technical solutions of the embodiments of this application, the following describes communication scenarios and related concepts that may be involved in the embodiments of this application.

The terminal initiates registration in a visited public land mobile network (VPLMN) 1, and a home public land mobile network (HPLMN) wishes to steer the terminal to leave the current VPLMN 1, and therefore the HPLMN sends steering of roaming (SOR) information 1 (for example, a list of preferred PLMN/access technology combinations 1 (list of preferred PLMN/access technology combinations 1), and/or a secured packet 1) to the terminal to steer the terminal. After receiving the SOR information 1, the terminal stores the SOR information 1 into an OPLMN list (“Operator Controlled PLMN Selector with Access Technology” list). In some scenarios, the terminal releases a connection, performs higher priority searching, leaves the VPLMN 1, and is registered in a VPLMN 2. When registered in the VPLMN 2, the HPLMN considers that there is no need to steer the terminal to leave the VPLMN 2 or to update OPLMNs in the terminal, and therefore sends send a “no change indication” to the terminal. After receiving the indication, the terminal does not update the OPLMNs, and does not perform a SOR procedure to be steered to another network. Then, when the terminal leaves coverage of the VPLMN 2 and enters the VPLMN 1 again, the terminal initiates mobility registration in the VPLMN 1 again, and the HPLMN still wishes to steer the terminal to leave the current VPLMN 1. However, the HPLMN finds that there is no need to change the OPLMN list stored in the terminal, and therefore sends “no change of the OPLMN list stored in the terminal is needed and thus no list of preferred PLMN/access technology combinations is provided (no change of the “Operator Controlled PLMN Selector with Access Technology” list stored in the UE is needed and thus no list of preferred PLMN/access technology combinations is provided)” to the terminal, namely, sends the “no change indication” to the terminal. However, after receiving the “no change indication”, the terminal does not perform steering, and continues to be registered with the VPLMN 1 to execute services.

Alternatively, in some other scenarios, the terminal performs higher priority searching after releasing a connection, the terminal leaves the VPLMN 1, and performs initial registration or mobility registration in the VPLMN 2. When registered in the VPLMN 2, the HPLMN considers that there is a need to steer the terminal to leave the VPLMN 2, but there is no need to update the OPLMNs in the terminal, and therefore sends the “no change indication” to the terminal. After receiving the indication, the terminal does not update the OPLMNs, and does not perform the SOR procedure to leave the VPLMN 2.

Alternatively, the terminal performs higher priority searching after releasing a connection, but cannot find a higher priority network, and therefore still initiates registration in the VPLMN 1. The HPLMN considers that there is a need to steer the terminal to leave the VPLMN 1, but there is no need to update the OPLMNs in the terminal, and therefore sends the “no change indication” to the terminal. After receiving the indication, the terminal does not update the OPLMNs, and does not perform the SOR procedure to leave the VPLMN 1.

This may lead to the situation that when the HPLMN wishes to steer the terminal to make a network change, the HPLMN sends the “no change indication” to the terminal because the OPLMNs are not changed. As a result, the terminal does not make a network change after receiving the “no change indication”. This may also cause the terminal to remain registered in the original network with poor network performance, small signal coverage, and expensive network charges. This is not conducive to terminal communication.

An embodiment of this application provides a network communication method.

With reference to the accompanying drawings, a network communication method provided in the embodiments of this application is described in detail below by using some embodiments and application scenarios thereof.

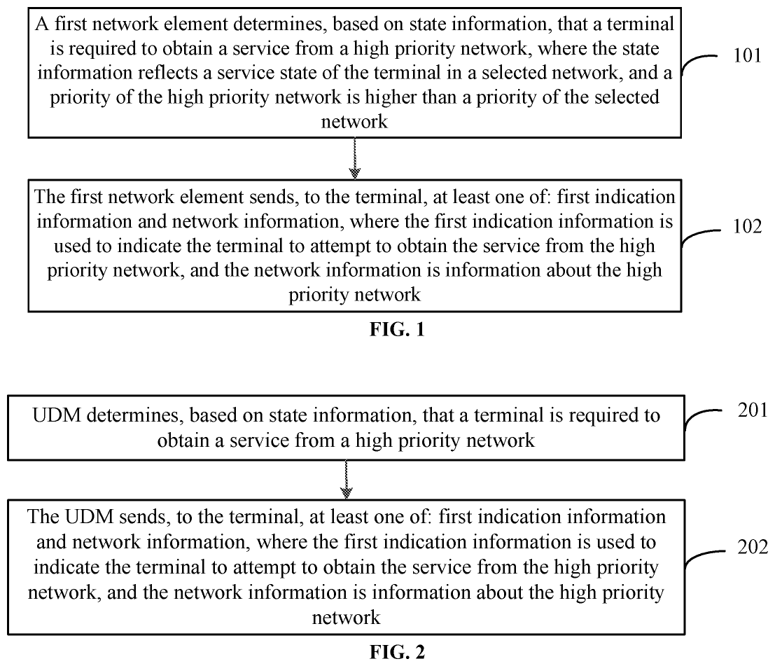

FIG. 1 is a first flowchart of a network communication method according to an embodiment of this application. As shown in FIG. 1, the method includes the following steps:

Step 101: A first network element determines, based on state information, that a terminal is required to obtain a service on a higher priority network, where the state information reflects a service state of the terminal in a selected network, and a priority of the higher priority network is higher than a priority of the selected network.

It should be noted that, the selected network may be a network currently accessed by the terminal or with which the terminal is currently registered. For example, the network currently selected by the terminal is a VPLMN 1, the higher priority network may be a VPLMN 2, and the priority of the VPLMN 2 is higher than that of the VPLMN 1. The higher priority may mean that the network has better communication performance, wider coverage, stronger network signals, cheaper charges, and the like. For another example, the network currently selected by the terminal is a stand-alone non-public network 1 (SNPN 1), and the higher priority network may be an SNPN 2, where the priority of the SNPN 2 is higher than that of the SNPN 1.

In this embodiment of this application, the state information includes at least one of the following: time information, position change information, and subscription information, where
the time information is reflected in a time of service of the terminal in the selected network;
the position information is reflected in a position change of the terminal in the selected network; and
the subscription information is reflected in a change of network subscription information of a network accessed by the terminal.

Optionally, the time information is duration between the current time and a moment at which the first network element sends an operator controlled public land mobile network selector with access technology (OPLMN) to the terminal last time. For example, in a case that the duration between the current time and the moment at which the first network element sends the OPLMN to the terminal for the last time, the first network element determines that the terminal is required to obtain the service on the higher priority network.

Optionally, the position information includes current position information of the terminal and position information of the terminal when the first network element sends the network information last time. Optionally, the position information may be at least one of: a cell identity, a tracking area identity (TAI), a satellite identity, and geographical position information of the terminal. For example, in a case that the first network element obtains that the current position information changes with respect to the position information of the terminal when the first network element sends the OPLMN last time, the first network element determines that the terminal is required to obtain the service on the higher priority network.

It should be noted that the subscription information is access and mobility subscription data. For example, if the first network element finds that the subscription information changes, the first network element determines that the terminal is required to obtain the service on the higher priority network.

Step 102: The first network element sends, to the terminal, at least one of: first indication information and network information, where the first indication information is used to indicate the terminal to attempt to obtain the service on the higher priority network, and the network information is information about the higher priority network.

For example, if the first network element sends the first indication information to the terminal, that is, indicates the terminal to attempt to obtain the service on the higher priority network (attempt to obtain service on a higher priority PLMN), the terminal may perform the SOR procedure based on the first indication information. In some scenarios, the first indication information may alternatively be used for indicating the terminal to perform the higher priority PLMN selection (the UE is required to perform the higher priority PLMN selection), or for indicating the terminal to perform the SOR procedure (the UE is required to perform SOR procedure).

Optionally, in some scenarios, the first indication information may alternatively be a steer identifier (also referred to as a STEER indication). For example, if the first network element is a UDM network element, and the UDM network element determines that the terminal is required to be steered, a steer identifier may be sent to the terminal, and a value of the steer identifier indicates the terminal to attempt to obtain the service on the higher priority network. If the UDM network element determines that the terminal is not required to be steered, a steer identifier may be sent to the terminal, where a value of the steer identifier indicates that the terminal is not required to attempt to obtain the service on the higher priority network.

Optionally, that the first network element sends the first indication information to the terminal includes:

The first network element sends a first message to the terminal, where the first message includes SOR information, and the SOR information includes the first indication information.

In other words, the first indication information (STEER indication) is carried in the SOR information sent by the first network element to the terminal.

Optionally, the SOR information includes a SOR header, and the SOR header includes the first indication information.

For example, the first network element is a UDM network element, and the UDM network element sends the first indication information to the terminal, to indicate the terminal to attempt to obtain the service on the higher priority network, where the first indication information is carried in the SOR header of the SOR message.

Optionally, the first indication information is carried in a list indication List indication field and/or a STEER indication field of the SOR header.

For example, as shown below, the STEER indication (namely, the steer identifier) may be added to the SOR header:

| 8 | 7 | 6 | 5 | 4 | 3 | 2 | 1 |
|---|---|---|---|---|---|---|---|
| 0 | 0 | STEER | AP | ACK | List | List | SOR data |
| Spare | Spare | indication | | | type | indication | type |

The STEER indication is 0 or 1, where 0 represents that the terminal is not required to perform the SOR procedure, and 1 represents that the terminal is required to perform the SOR procedure. Alternatively, the STEER indication is 0 or 1. When the STEER indication is 0 and the list indication List indication is 0, it indicates that the terminal is not required to perform the SOR procedure; and when the STEER indication is 1 and the list indication List indication is 0, it indicates that the terminal is required to perform the SOR procedure.

It should be noted that, when the List indication is 0, it indicates an HPLMN indication that there is no need to change the OPLMN list stored in the terminal and that no list of preferred PLMN/access technology combinations is provided (HPLMN indication that no change of the “Operator Controlled PLMN Selector with Access Technology” list stored in the UE is needed and thus no list of preferred PLMN/access technology combinations is provided).

In this embodiment of this application, the first network element may alternatively send the network information to the terminal, where the network information is the information about the higher priority network, and the terminal performs the SOR procedure based on the network information, for example, obtains the service on the corresponding higher priority network based on the network information.

Optionally, the network information includes at least one of the following:
a list of preferred PLMN/access technology combinations; and
a secured packet.

It should be noted that, the secured packet may be an encrypted list of preferred PLMN/access technology combinations.

In this embodiment of this application, the first network element determines, based on the service state of the terminal in the selected network, that the terminal is required to obtain the service on the higher priority network, then the first network element sends the first indication information and/or the network information to the terminal, to enable the terminal to attempt to obtain the service on the higher priority network, for example, perform the SOR procedure, based on the first indication information and/or the network information. In this way, the first network element can trigger, based on the service state of the terminal in the selected network without changing the OPLMN stored in the terminal, the terminal to perform the SOR procedure, so that the terminal can attempt to obtain the service on the higher priority network. This also enables the terminal to select a network more flexibly and ensures that the terminal can obtain better network services.

In this embodiment of this application, the first network element may be a unified data management (UDM) network element, or an application function (AF) network element, for example, a SoR application function (SoF-AF) network element. For example, the first network element is a UDM network element, and the UDM network element may determine on its own, based on the state information, for example, in a case that the position information of the terminal changes, that the terminal is required to obtain the service on the higher priority network, to further send the first indication information to the terminal; or may send a request to the AF network element, to request the information about the higher priority network. For another example, the first network element is an AF network element, and the AF network element may feed back the information about the higher priority network to the UDM network element based on a request sent by the UDM network element, or the AF network element determines on its own, based on the state information, that the terminal is required to obtain the service on the higher priority network.

Optionally, step 101 may include:

The first network element determines that an OPLMN list stored in the terminal does not need to be changed, and determines, based on the state information, that the terminal is required to obtain the service on the higher priority network.

For example, the first network element is a UDM network element, and that the first network element determines, that the OPLMN list stored in the terminal does not need to be changed, and determines, based on the state information, that the terminal is required to obtain the service on the higher priority network includes:

In response to that SOR information that is of the terminal and that is received from an application function AF network element does not include the network information, the UDM network element determines that the OPLMN list stored in the terminal does not need to be changed, and determines, based on the state information, that the terminal is required to obtain the service on the higher priority network.

In this scenario, the first network element is the UDM network element, and the UDM network element may send a request for the SOR information to the AF network element, and the AF network element sends the SOR information to the UDM network element in response to the request. The SOR information does not include the network information, for example, does not include the “list of preferred PLMN/access technology combinations, secured packet”. The UDM network element determines, based on the SOR information, that there is no need to change the OPLMN list stored in the terminal, but may still determine, based on the service state of the terminal in the selected network, that the terminal is required to obtain the service on the higher priority network, so that the first network element can send the first indication information and/or the network information to the terminal, so that the terminal can attempt to obtain the service on the higher priority network, thereby ensuring that the terminal can flexibly select a network service, and ensuring that the terminal obtains a relatively good network service.

Optionally, in a case that the first network element is the UDM network element, before that the first network element determines that there is no need to change the OPLMN list stored in the terminal, and determines, based on the state information, that the terminal is required to obtain the service on the higher priority network, the method further includes:

The UDM network element receives second indication information from the AF network element, where the second indication information is used to indicate no change of the OPLMN list stored in the terminal.

In this scenario, the AF network element may send the second indication information to the UDM network element based on a request sent by the UDM network element for requesting the SOR information; or the AF network element may send the second indication information to the UDM network element based on the service state of the terminal in the selected network (namely, the state information). For example, the AF network element actively sends the second indication information to the UDM network element when obtaining that the position of the terminal changes. Certainly, the state information may alternatively be other possible cases, which are not listed one by one in this embodiment.

The second indication information is used to indicate no change of the OPLMN list stored in the terminal (no change of the “Operator Controlled PLMN Selector with Access Technology” list stored in the USIM is needed). In some scenarios, the second indication information may also be referred to as a no change indication.

In a case that the UDM network element receives the second indication information sent by the AF network element, the UDM network element determines, based on the second indication information, that there is no need to change the OPLMN list stored in the terminal, but determines, based on the state information, that the terminal is required to obtain the service on the higher priority network.

Optionally, the first network element is a UDM network element, and before step 102, the method may further include:

The UDM network element sends a first request to an AF network element, where the first request includes third indication information, and the third indication information is used to indicate the AF network element to send the network information to the UDM network element.

For example, the UDM network element may send the first request carrying the third indication information to the AF network element in a case of receiving a registration request sent by the terminal, to indicate the AF network element to send the information about the higher priority network to the UDM network element. For example, the third indication information may be an OPLMN indication identifier that indicates that the AF network element is required to provide the OPLMN; and the AF network element can determine, based on the OPLMN indication identifier, whether to provide the OPLMN to the UDM network element.

In this scenario, the AF network element may provide, based on the third indication information, the information about the higher priority network (namely, the network information), for example, a list of preferred PLMN/access technology combinations, and/or a secured packet, to the UDM network element, and the UDM network element sends, based on the received information about the higher priority network, the information about the higher priority network to the terminal, to enable the terminal to perform the SOR procedure.

Alternatively, the UDM network element may query the AF network element for the SOR information after the terminal completes registration. Optionally, the first request is a SOR information query request, for example, Nsoraf_SoR_Get. In this scenario, after the terminal completes registration, the UDM network element may query the AF network element for latest SOR information, and may further send the SOR information query information to the AF network element, to obtain the latest SOR information.

In this embodiment of this application, in a case that the first network element is a UDM network element, that the first network element sends the network information to the terminal includes:

The UDM network element sends, to the terminal, the network information stored by the UDM network element.

The network information stored by the UDM network element may be network information the same as the network information sent to the terminal last time.

Optionally, that the UDM network element sends, to the terminal, the network information stored by the UDM network element includes:

The UDM network element sends, to the terminal, stored network information that is sent to the terminal last time.

In this embodiment of this application, the method further includes:

The first network element determines, based on the state information, that the terminal is not required to obtain the service on the higher priority network, and the first network element sends the second indication information to the terminal, where the second indication information is used to indicate no change of the OPLMN list stored in the terminal.

For example, the first network element is the UDM network element, and the UDM network element determines, based on the position information of the terminal, for example, the position of the terminal does not change, that the terminal is not required to obtain the service on the higher priority network. The UDM network element may send the second indication information (which may also be referred to as the no change indication in some scenarios) to the terminal, to indicate no change of the OPLMN list stored in the terminal. In this case, the terminal may not perform the SOR procedure. For example, the terminal may not release a connection (do not release the current N1 NAS signaling connection), or not attempt to obtain the service on the higher priority network (do not attempt to obtain service on a higher priority PLMN), or the like.

Alternatively, the first network element may be the AF network element, and the AF network element may also determine, based on the state information, that the terminal is not required to obtain the service on the higher priority network. In this case, the AF network element sends the second indication information to the terminal, to indicate no change of the OPLMN list stored in the terminal. Refer to the foregoing descriptions for details. Details are not described herein again.

Optionally, the first network element is the UDM network element, and the method further includes:

The UDM network element determines, based on the state information, that the terminal is not required to obtain the service on the higher priority network, and sends fourth indication information to the AF network element, where the fourth indication information is used to indicate that the network information is not mandatorily provided.

In this scenario, if the UDM network element determines, based on the state information, that the terminal is not required to obtain the service on the higher priority network, the UDM network element may send the fourth indication information to the AF network element, to indicate, to the AF network element, that the network information, for example, the OPLMN, is not mandatorily provided. Further, the AF network element may determine, on its own based on the fourth indication information, whether to provide the network information to the UDM network element.

Optionally, the first network element is an AF network element, and before that the first network element determines, based on the state information, that the terminal is required to obtain the service on the higher priority network, the method further includes:

The AF network element receives fourth indication information from the UDM network element, where the fourth indication information is used to indicate that the network information is not mandatorily provided.

It may be understood that, based on the fourth indication information, the AF network element may provide the network information, for example, the OPLMN, or may not provide the network information to the UDM network element.

In this embodiment of this application, in a case that the first network element is the AF network element, and before that the first network element determines, based on the state information, that the terminal is required to obtain the service on the higher priority network, the method further includes:

The AF network element receives the state information from the UDM network element.

For example, the terminal sends the registration request to the UDM network element, and the UDM network element sends the state information to the AF network element based on the registration request, so that the AF network element can obtain the service state of the terminal in the selected network based on the state information, to determine that the terminal is required to obtain the service on the higher priority network. Further, the AF network element can send at least one of the first indication information and the network information to the terminal, so that the terminal can perform the SOR procedure.

It should be noted that, that the terminal performs the SOR procedure may include at least one of the following:
deleting PLMNs indicated by preferred PLMN/access technology combinations from a forbidden PLMN list and from a list of forbidden PLMNs for general packet radio service (GPRS) service;
deregistering from a registered network;
releasing a NAS signaling connection; and
attempting to obtain the service on the higher priority network.

Optionally, if steering of roaming connected mode control information (SOR-CMCI) exists, a SOR-CMCI procedure is performed.

Based on the solution provided in this embodiment of this application, the first network element can trigger, based on the service state of the terminal in the selected network, the terminal to perform the SOR procedure, so that the terminal can attempt to obtain the service on the higher priority network. This also enables the terminal to select a network more flexibly and ensures that the terminal can obtain better network services.

For better understanding, the following describes the network communication method provided in the embodiments of this application by using examples in which the first network element is separately a UDM network element (UDM for short in some subsequent scenarios) and an AF network element (AF for short in some subsequent scenarios).

FIG. 2 is a second flowchart of a network communication method according to an embodiment of this application. In this embodiment of this application, the method is applied to UDM. As shown in FIG. 2, the method includes:

Step 201: The UDM determines, based on state information, that a terminal is required to obtain a service on a higher priority network.

The state information reflects a service state of the terminal in a selected network, and a priority of the higher priority network is higher than a priority of the selected network. The state information includes at least one of the following: time information, position change information, and subscription information. Refer to the descriptions in the embodiment of FIG. 1 for details. Details are not described herein again.

In this embodiment of this application, before step 201, the method further includes:

The UDM receives SOR information sent by an AF.

In this case, when receiving the SOR information sent by the AF, the UDM may determine, based on the SOR information, whether the terminal is required to obtain the service on the higher priority network. For example, the SOR information may include information used for selecting the higher priority network, and the UDM determines, based on the information used for selecting the higher priority network, that the terminal is required to obtain the service on the higher priority network; or the SOR information may not include the information for selecting the higher priority network, and the UDM determines, based on that SOR information, whether the terminal is required to obtain the service on the higher priority network.

Optionally, in a case that the SOR information does not include the information used for selecting the higher priority network, the UDM determines, based on the SOR information, that there is no need to change an OPLMN list stored in the terminal, and the UDM determines that the terminal is not required to obtain the service on the higher priority network.

Alternatively, in a case that the SOR information does not include the information used for selecting the higher priority network, the UDM determines, based on the SOR information, that there is no need to change the OPLMN stored in the terminal, and the UDM determines that the terminal is required to obtain the service on the higher priority network.

In other words, in a case that the SOR information sent by the AF does not include the information for selecting the higher priority network, the UDM may determine, in two different implementations, whether the terminal is required to obtain the service on the higher priority network.

Implementation 1: When the UDM determines, based on the SOR information, that there is no need to change the OPLMN stored in the terminal, the UDM may determine that the terminal is not required to obtain the service on the higher priority network.

In this implementation, the method may further include:

The UDM sends second indication information to an AMF, where the second indication information is used to indicate that there is no need to change the OPLMN list stored in the terminal (no change of the “Operator Controlled PLMN Selector with Access Technology” list stored in the UE) and is used to indicate that no list of preferred PLMN/access technology combinations is provided (no list of preferred PLMN/access technology combinations is provided). In some scenarios, the second indication information may also be referred to as a no change indication.

Further, after receiving the second indication information sent by the UDM, the AMF sends the second indication information to the terminal, and the terminal determines, based on the second indication information, that there is no need to change the stored OPLMN list, that is, there is no need to change a network, and the terminal may remain registered in the target network to obtain the service.

Implementation 2: In a case that the SOR information sent by the AF does not include the information used for selecting the higher priority network, the UDM determines, based on the SOR information, that there is no need to change the OPLMN stored in the terminal, but the UDM determines that the terminal is required to obtain the service on the higher priority network. In this case, the UDM does not send the second indication information (or referred to as the no change indication) to the AMF.

Optionally, in this implementation, the method further includes:

The UDM sends the information used for selecting the higher priority network to the terminal.

In other words, if the UDM wishes to steer the terminal, even if there is no need to change the OPLMN stored in the terminal, the UDM may send the information used for selecting the higher priority network (also referred to as network information) to the terminal, for example, preferred PLMN information, to further steer the terminal to perform the SOR procedure.

Optionally, the information that is used for selecting the higher priority network and that is sent by the UDM to the terminal is information that is used for selecting the higher priority network and that is sent to the terminal last time.

In addition, after that the UDM sends the information used for selecting the higher priority network to the terminal, the method further includes:

The UDM stores the information used for selecting the higher priority network.

It may be understood that, the UDM stores the information used for selecting the higher priority network, so that in a case that the UDM determines again that the terminal is required to obtain the service on the higher priority network, the UDM may send the stored information for selecting the higher priority network to the terminal.

The information used for selecting the higher priority network includes at least one of the following:
a list of preferred PLMN/access technology combinations; and
a secured packet.

In this embodiment of this application, the AF may actively send the SOR information to the UDM. For example, in a case that the time information, the position information of the terminal, or the like changes, the AF may actively send the SOR information to the UDM, to enable the UDM to determine, based on the SOR information, whether the terminal is required to obtain the service on the higher priority network.

Alternatively, before that the UDM receives the SOR information sent by the AF, the method further includes:

The UDM sends a first request for requesting the SOR information to the AF.

In this implementation, the AF feeds back the SOR information to the UDM after receiving the first request that is used for requesting the SOR information and that is sent by the UDM.

Optionally, in a case of receiving a second request that is used for requesting the SOR information and that is sent by the AMF, the UDM may determine whether the terminal is required to obtain the service on the higher priority network; and in a case that the UDM determines that the terminal is required to obtain the service on the higher priority network, the UDM sends the first request used for requesting the SOR information to the AF.

For example, the terminal initiates a network registration request to the AMF, and the AMF sends the second request requesting the SOR information to the UDM based on the registration request; and after receiving the second request, the UDM may first determine whether there is a need to steer the terminal, that is, whether the terminal is required to obtain the service on the higher priority network, and if the terminal is required to obtain the service on the higher priority network, the UDM sends the first request requesting the SOR information to the AF. Optionally, the UDM may request the SOR information from the AF by using an interface Nsoraf_SteeringOfRoaming (Nsoraf_SOR) GET request.

Optionally, the first request includes an OPLMN indication identifier, where the OPLMN indication identifier is used to indicate whether the AF is required to provide an OPLMN. It should be noted that, after receiving the first request from the interface Nsoraf_SteeringOfRoaming (Nsoraf_SOR) GET request, the AF determines, according to the OPLMN indication identifier provided by the UDM, whether to provide the OPLMN to the UDM. In a case that the OPLMN indication identifier indicates that the AF must provide the OPLMN, the SOR information sent by the AF to the UDM includes the OPLMN; or in a case that the OPLMN indication identifier indicates that the AF does not mandatorily provide the OPLMN, the SOR information sent by the AF to the UDM may include the OPLMN, or may not include the OPLMN.

Optionally, the OPLMN indication identifier includes at least one of the following: time information, position change information, and an index and an indication of an OPLMN. The indication is used to indicate whether the AF must feed back the OPLMN.

Optionally, the time information is duration between a current time and a moment at which the AF sends the OPLMN last time. For example, the OPLMN indication identifier includes the duration between the current time and the moment at which the AF sends the OPLMN last time. If the AF finds that the duration exceeds preset duration, the AF feeds back the OPLMN to the UDM. The OPLMN fed back by the AF may be the same as or different from the OPLMN stored in the UE.

Optionally, the OPLMN indication identifier includes the position change information. For example, if the AF finds, based on the OPLMN indication identifier, that current position information of the terminal changes with respect to position information of the terminal when the AF sends the OPLMN last time, the AF feeds back the OPLMN to the UDM; and the OPLMN fed back by the AF may be the same as or different from the OPLMN stored in the UE.

Optionally, the OPLMN indication identifier may further include the indication. If the indication indicates that the AF must feed back the OPLMN, the AF feeds back the OPLMN to the UDM based on the indication, regardless of whether the OPLMN changes compared with the OPLMN stored in the terminal. If the indication indicates that the AF does not mandatorily feed back the OPLMN, the AF may determine, on its own, whether to provide the OPLMN to the UDM.

Step 202: The UDM sends, to the terminal, at least one of: first indication information and network information, where the first indication information is used to indicate the terminal to attempt to obtain the service on the higher priority network, and the network information is information about the higher priority network.

Optionally, that the UDM sends the first indication information to the terminal includes:

The UDM sends a first message to the terminal, where the first message includes SOR information, and the SOR information includes the first indication information.

In some scenarios, the first indication information may alternatively be a steer identifier, where the steer identifier is used to indicate the terminal to attempt to obtain the service on the higher priority network, and may also be used to indicate that the terminal is not required to attempt to obtain the service on the higher priority network. Optionally, the SOR information includes a SOR header, where the SOR header includes the first indication information.

Further, the first indication information is carried in a list indication List indication field and/or a STEER indication field of the SOR header.

For example, the UDM receives the SOR information from the AF, and if the SOR information includes a no change indication, namely, an indication that there is no need to change the OPLMN list stored in the terminal, the UDM may send the first message including the SOR header to the terminal, where the SOR header includes the steer identifier, to indicate the terminal to attempt to obtain the service on the higher priority network. Optionally, the steer identifier may occupy one or several bits in the SOR header, to indicate whether the terminal is required to attempt to obtain the service on the higher priority network. For example, a steer identifier of 0 indicates that the terminal is not required to attempt to obtain the service on the higher priority network, and a steer identifier of 1 indicates that the terminal is required to attempt to obtain the service on the higher priority network. Refer to the descriptions in the embodiment of FIG. 1 for details. Details are not described herein again.

Optionally, the first message is a non-access stratum (NAS) message or an access stratum (AS) message.

Optionally, the NAS message is any one of the following: a registration accept message, a downlink NAS transport (DL NAS TRANSPORT) message, a registration reject message, a deregistration accept message, a deregistration request message, a deregistration reject message, a service reject message, a service accept message, a configuration update command message, an authentication request message, an authentication response message, an authentication reject message, an authentication result message, an identity request message, a security mode command message, a 5GMM status message, and a notification message.

In this embodiment of this application, the method may further include:

The UDM sends a query request to the AF, where the query request is used to request to query the SOR information.

For example, after the terminal has been successfully registered with a VPLMN, for example, after the UE performs the SOR procedure based on the first indication information and/or the information used for selecting the higher priority network and is successfully registered with the VPLMN, when the UDM finds that there is a need to steer the terminal, for example, after a period of time has elapsed or the position information of the terminal changes (for example, a cell changes, a TAI changes, satellite information changes, or the like), the UDM may send the query request to the AF, to query latest SOR information. After receiving the query request, the AF may send found target SOR information to the UDM by using an interface Nsoraf_SoR_Get response.

Optionally, after that the UDM sends the query request to the AF, the method further includes:

The UDM receives the target SOR information sent by the AF in response to the query request; and
the UDM sends the target SOR information to the AMF.

It should be noted that, after receiving the target SOR information sent by the AF, the UDM may send the target SOR information to the AMF by using an Nudm_SDM_Notification interface.

Optionally, after that the UDM sends the query request to the AF, the method further includes:

If the UDM does not receive, within preset duration, the target SOR information sent by the AF in response to the query request, the UDM continues to send the query request to the AF or stops sending the query request to the AF.

For example, after the UDM sends the query request to the AF, if the UDM does not receive, within a particular time, the target SOR information fed back by the AF, the UDM may re-send the query request to the AF, or may stop the process of sending the query request, and perform a deregistration operation on the terminal.

In this embodiment of this application, the UDM can determine, based on the service state of the terminal in the selected network, that the terminal is required to obtain the service on the higher priority network, and then sends the first indication information and/or the information that is used to select the higher priority network to the terminal, to trigger the terminal to perform the SOR procedure, so that the terminal can attempt to obtain the service on the higher priority network.

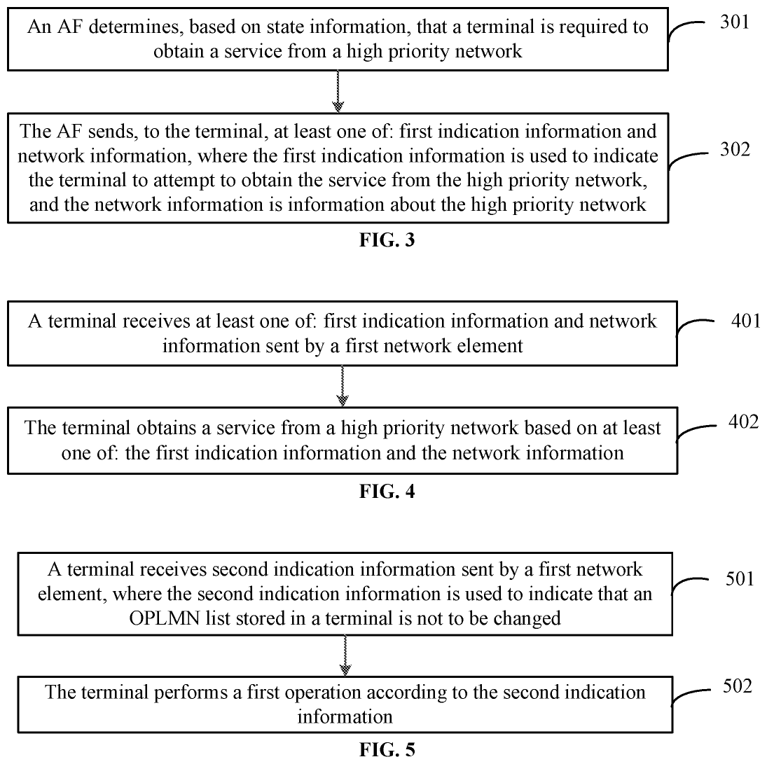

FIG. 3 is a third flowchart of a network communication method according to an embodiment of this application. In this embodiment of this application, the method is applied to an AF. As shown in FIG. 3, the method includes:

Step 301: The AF determines, based on state information, that a terminal is required to obtain a service on a higher priority network.

The state information reflects a service state of the terminal in a selected network, and a priority of the higher priority network is higher than a priority of the selected network. The state information includes at least one of the following: time information, position change information, and subscription information. Refer to the descriptions in the embodiment of FIG. 1 for details. Details are not described herein again.

Optionally, before step 301, the method further includes:

The AF receives the state information from UDM.

It may be understood that, the AF determines, based on the state information sent by the UDM, that the terminal is required to obtain the service on the higher priority network.

Optionally, before step 301, the method may further include:

The AF receives fourth indication information from the UDM, where the fourth indication information is used to indicate that the network information is not mandatorily provided.

It should be noted that, the fourth indication information may alternatively an indication. If the indication indicates that the AF does not mandatorily feed back an OPLMN, the AF may determine, on its own, whether to provide the OPLMN to the UDM. Optionally, the indication may be further used to indicate that the AF must feed back the OPLMN. In this case, the AF feeds back the OPLMN to the UDM based on the indication, regardless of whether the OPLMN changes compared with an OPLMN stored in the terminal.

Step 302: The AF sends, to the terminal, at least one of: first indication information and network information, where the first indication information is used to indicate the terminal to attempt to obtain the service on the higher priority network, and the network information is information about the higher priority network.

Optionally, that the AF sends the first indication information to the terminal includes:

The AF sends a first message to the terminal, where the first message includes SOR information, and the SOR information includes the first indication information.

In some scenarios, the first indication information may alternatively be a steer identifier, where the steer identifier is used to indicate the terminal to attempt to obtain the service on the higher priority network, and may also be used to indicate that the terminal is not required to attempt to obtain the service on the higher priority network.

Optionally, the SOR information includes a SOR header, and the SOR header includes the first indication information.

Further, the first indication information is carried in a list indication List indication field and/or a STEER indication field of the SOR header.

Optionally, the steer identifier may occupy one or several bits in the SOR header, to indicate whether the terminal is required to attempt to obtain the service on the higher priority network. For example, a steer identifier of 0 indicates that the terminal is not required to attempt to obtain the service on the higher priority network, and a steer identifier of 1 indicates that the terminal is required to attempt to obtain the service on the higher priority network. Refer to the descriptions in the embodiment of FIG. 1 for details. Details are not described herein again.

Optionally, the first information is a non-access stratum (NAS) message or an access stratum (AS) message.

Optionally, the NAS message is any one of the following: a registration accept message, a downlink NAS transport (DL NAS TRANSPORT) message, a registration reject message, a deregistration accept message, a deregistration request message, a deregistration reject message, a service reject message, a service accept message, a configuration update command message, an authentication request message, an authentication response message, an authentication reject message, an authentication result message, an identity request message, a security mode command message, a 5GMM status message, and a notification message.

In this embodiment of this application, the method may further include:

The AF sends the SOR information to the UDM.

Optionally, in a case that the AF determines that there is no need to change the OPLMN stored in the terminal, and that the terminal is not required to obtain the service on the higher priority network, the SOR information does not include information used for selecting the higher priority network. In this case, if the AF considers that the terminal is not required to perform a SOR procedure, or in other words, the terminal is not required to attempt to obtain the service on the higher priority network, the SOR information sent by the AF to the UDM does not include the information used for selecting the higher priority network (namely, the foregoing network information), indicating that there is no need to change the OPLMN list stored in the terminal (that is, no change of the “Operator Controlled PLMN Selector with Access Technology” list stored in the USIM is needed).

Alternatively, in a case that the AF determines that there is no need to change the OPLMN stored in the terminal, but the terminal is required to obtain the service on the higher priority network, the SOR information includes the information used for selecting the higher priority network.

Optionally, in a case that the SOR information includes the information used for selecting the higher priority network, the SOR information includes the information that is used for selecting the higher priority network and that is sent to the terminal last time.

In this embodiment of this application, the information used for selecting the higher priority network includes at least one of the following:
a list of preferred PLMN/access technology combinations; and
a secured packet.

In this embodiment of this application, the AF may actively send the SOR information to the UDM. For example, the AF may actively send the carried SOR information to the UDM in a case that obtained position information of the terminal changes, or duration between a current time and a moment at which the AF sends the OPLMN to the terminal last time exceeds preset duration, or subscription information of the terminal changes, so that the UDM can determine, based on the SOR information, whether the terminal is required to obtain the service on the higher priority network.

Alternatively, the AF may send the SOR information to the UDM in a case that the UDM requests the SOR information. Optionally, the method further includes:

The AF receives, from the UDM, a first request for requesting the SOR information.

Optionally, the first request sent by the UDM includes an OPLMN indication identifier, where the OPLMN indication identifier is used to indicate whether the AF is required to provide the OPLMN.

Optionally, the OPLMN indication identifier includes at least one of the following: time information, position information, and an index and an indication of an OPLMN, where the indication is used to indicate whether the AF must feed back the OPLMN. If the indication indicates that the AF must feed back the OPLMN, the AF feeds back the OPLMN to the UDM, regardless of whether the OPLMN changes compared with the OPLMN stored in the terminal. If the indication indicates that the AF does not mandatorily feed back the OPLMN, the AF may determine, on its own, whether to provide the OPLMN to the UDM.

In this embodiment of this application, after that the AF receives, from the UDM, the first request for requesting the SOR information, the method further includes:
The AF determines, based on the OPLMN indication identifier, whether the SOR information sent to the UDM includes the OPLMN;
in a case that the OPLMN indication identifier indicates that the AF must provide the OPLMN, the SOR information sent by the AF to the UDM includes the OPLMN; and
in a case that the OPLMN indication identifier indicates that the AF does not mandatorily provide the OPLMN, the SOR information sent by the AF to the UDM includes the OPLMN or does not include the OPLMN.

Optionally, in a case that the OPLMN indication identifier indicates that the AF does not mandatorily provide the OPLMN, if the OPLMN provided by the AF is the same as the OPLMN stored in the terminal, the SOR information sent by the AF to the UDM does not include the OPLMN.

In this embodiment of this application, the method may further include:

The AF obtains a query request sent by the UDM, where the query request is used to request to query the SOR information.

For example, after the terminal has been successfully registered with a VPLMN for a period of time, the UDM sends the query request for querying latest SOR information to the AF; or in a case that the position information of the terminal changes, for example, geographical position information of the terminal changes, or a cell corresponding to the terminal changes, the UDM may send the query request to the AF.

Further, after that the AF obtains the query request sent by the UDM, the method may further include:

The AF sends target SOR information to the UDM in response to the query request.

It may be understood that, after receiving the query request sent by the UDM, the AF may send the target SOR information to the UDM by using an Nsoraf_SoR_Get response interface, where the target SOR information may be the latest SOR information.

In this embodiment of this application, the AF can determine, based on the service state of the terminal in the selected network, that the terminal is required to obtain the service on the higher priority network, and then sends the first indication information and/or the information that is used to select the higher priority network to the terminal, to trigger the terminal to perform the SOR procedure, so that the terminal can attempt to obtain the service on the higher priority network.

FIG. 4 is a fourth flowchart of a network communication method according to an embodiment of this application. In this embodiment of this application, the method is applied to a terminal. As shown in FIG. 4, the method includes the following steps:

Step 401: The terminal receives at least one of: first indication information and network information sent by a first network element.

The first indication information is used to indicate to obtain a service on a higher priority network, the network information is information about the higher priority network, and a priority of the higher priority network is higher than a priority of a selected network.

Optionally, the network information includes at least one of the following:
a list of preferred PLMN/access technology combinations; and
a secured packet.

Optionally, that the terminal receives the first indication information sent by the first network element includes:

The terminal receives a first message sent by the first network element, where the first message includes SOR information, and the SOR information includes the first indication information.

Optionally, the SOR information includes a SOR header, and the SOR header includes the first indication information.

Optionally, the first indication information is carried in a list indication List indication field and/or a STEER indication field of the SOR header.

Optionally, the method further includes:
The terminal receives second indication information sent by the first network element, where the second indication information is used to indicate no change of an OPLMN list stored in the terminal.

It should be noted that, refer to the descriptions in the foregoing embodiments for specific implementations of the first indication information, the network information, and the second indication information. Details are not described herein again.

Step 402: The terminal attempts to obtain the service on the higher priority network based on at least one of: the first indication information and the network information.

In this embodiment of this application, that the terminal obtains the service on the higher priority network includes:

The terminal performs a SOR procedure.

Optionally, that the terminal performs the SOR procedure includes at least one of the following:
deleting PLMNs indicated by preferred PLMN/access technology combinations from a forbidden PLMN list and from a list of forbidden PLMNs for GPRS service;
deregistering from a registered network; and
releasing a NAS signaling connection.

If SOR-CMCI exists, a SOR-CMCI procedure is performed.

Optionally, the terminal may further store or not store the received network information (or referred to as information used for selecting the higher priority network) into the OPLMN list of the terminal.

For example, if the currently received network information is the same as network information received last time, the currently received network information is not stored into the OPLMN list of the terminal; or if the currently received network information is different from the network information received last time, the currently received network information is stored into the OPLMN list of the terminal.

In this embodiment of this application, before step 401, the method further includes:

The terminal sends a registration request to an AMF, to enable the AMF to send a second request for requesting the SOR information to UDM, where the UDM can determine, based on the SOR information, that the terminal is required to obtain the service on the higher priority network.

For example, the terminal sends the registration request to the AMF, and the AMF sends, to the UDM based on the registration request, the second request for requesting the SOR information. Further, the UDM sends a first request for requesting the SOR information to the AF based on the second request. The AF may send the SOR information to the UDM in response to the first request. The UDM determines, based on the SOR information, that the terminal is required to obtain the service on the higher priority network, and sends the first indication information and/or the network information to the terminal, where the network information includes the SOR information.

In this embodiment of this application, the terminal can obtain, based on the first indication information and/or the network information sent by the first network element, the service on the higher priority network. This also enables the terminal to select a network more flexibly and ensures that the terminal can obtain better network services.

FIG. 5 is a fifth flowchart of a network communication method according to an embodiment of this application. In this embodiment of this application, the method is applied to a terminal. As shown in FIG. 5, the method includes the following steps:

Step 501: The terminal receives second indication information sent by a first network element, where the second indication information is used to indicate no change of an OPLMN list stored in the terminal.

Step 502: The terminal performs a first operation according to the second indication information.

The first operation includes at least one of following:
in a case that a UDM network element does not require to obtain an ACK from the terminal, skipping sending a registration complete message to an AMF network element, where a SOR transparent container of the registration complete message carries the ACK; and
after an N1 NAS signaling connection is released, attempting or skipping attempting to obtain a service on a higher priority PLMN.

In this embodiment of this application, the second indication information is used to indicate no change of the OPLMN list stored in the terminal. In some scenarios, the second indication information may also be referred to as a no change indication (no change of the “Operator Controlled PLMN Selector with Access Technology” list stored in the USIM).

The first network element is a UDM network element or an AF network element. In a case that the terminal receives the second indication information sent by the first network element, if the UDM network element does not require the terminal to feed back the ACK, the terminal does not send a registration complete message to an AMF network element, where the ACK is carried in a transparent container of the registration complete message (for example, the following is not executed: The UE sends the REGISTRATION COMPLETE message to the serving AMF with an SOR transparent container including the UE acknowledgement).

In this scenario, further, the AMF network element does not forward the ACK to the UDM network element (for example, the following is not executed: the AMF uses the Nudm_SDM_Info service operation to provide the received SOR transparent container to the UDM); and the UDM network element does not forward the ACK to the AF network element.

Optionally, after receiving the second indication information, the terminal may alternatively perform the following operation: releasing an N1 NAS signaling connection, and attempting to obtain the service on a higher priority PLMN, for example, attempting to obtain the service on the higher priority PLMN as specified in clause 4.4.3.3 of the protocol after the release of the N1 NAS signaling connection (attempt to obtain service on a higher priority PLMN as specified in clause 4.4.3.3 by acting as if timer T that controls periodic attempts has expired after the release of the N1 NAS signaling connection); and if SOR-CMCI exists, a SOR-CMCI procedure is performed.

Alternatively, after receiving the second indication information, the terminal may alternatively perform: skipping attempting to obtain the service on the higher priority PLMN.

Alternatively, after receiving the second indication information, the terminal may alternatively perform: in a case that the UDM network element does not require to obtain the acknowledgement ACK from the terminal, skipping sending the registration complete message to the AMF network element; and releasing the N1 NAS signaling connection, and attempting to obtain the service on the higher priority PLMN.

Alternatively, after receiving the second indication information, the terminal may alternatively perform: in a case that the UDM network element does not require to obtain the acknowledgement ACK from the terminal, skipping sending the registration complete message to the AMF network element; and skipping attempting to obtain the service on the higher priority PLMN.

In this embodiment of this application, even if the OPLMN list stored in the terminal is not changed, the terminal may still attempt or not attempt to obtain the higher priority PLMN after the N1 NAS signaling connection is released, and/or in a case that the UDM network element does not require to obtain the ACK from the terminal, the terminal does not send the registration complete message to the AMF network element. In this way, the terminal can still flexibly perform the SOR procedure, and attempt to obtain the service on the higher priority network, to ensure that the terminal can obtain better network services.

For better understanding, the following describes the technical solutions of this application by using several specific embodiments.

### Embodiment 1

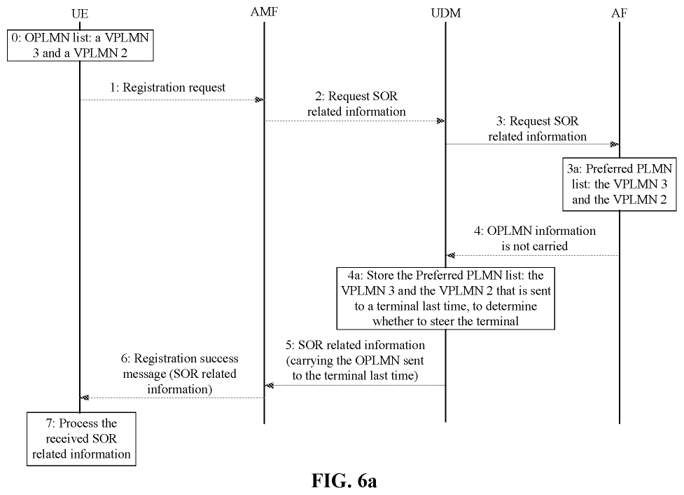

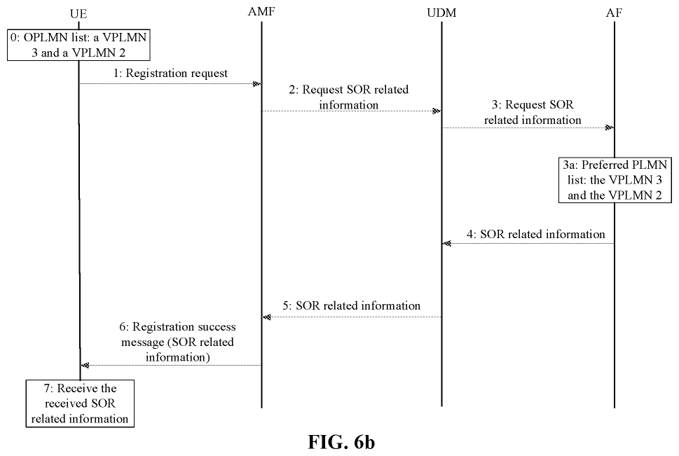

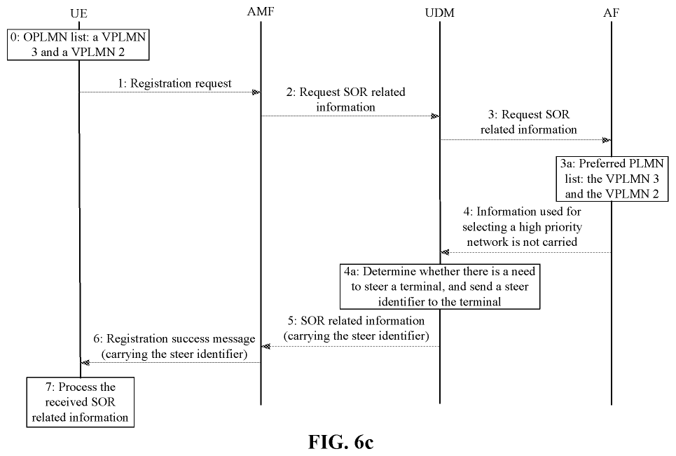

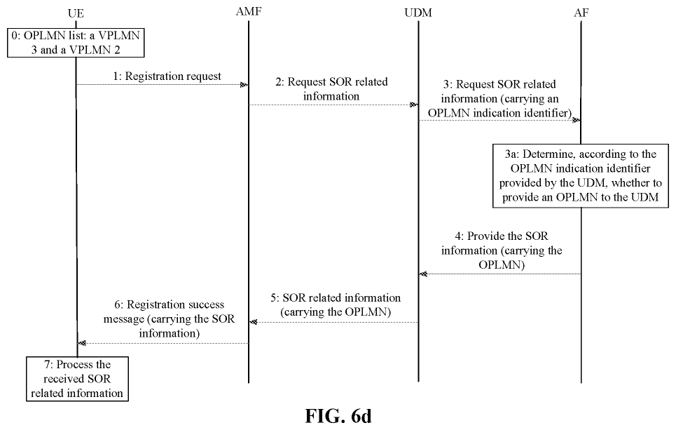

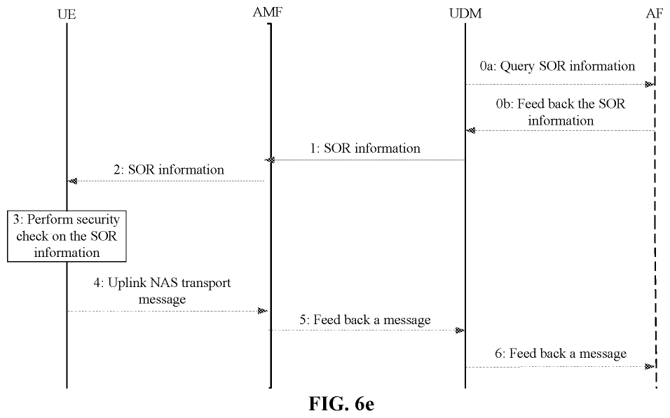

FIG. 6a is a first schematic diagram of a scenario of a network communication method according to an embodiment of this application. As shown in FIG. 6a, the method includes the following steps:
0: A terminal (UE) stores an OPLMN list: a VPLMN 3 and a VPLMN 2.
1: The terminal initiates a registration request to an AMF.
2: The AMF requests SOR related information from UDM based on the registration request.
3: The UDM requests the SOR related information from an AF.
3a: The AF stores OPLMN information, for example, preferably, a preferred PLMN list: the VPLMN 3 and the VPLMN 2.
4: The AF sends a message to the UDM, where the message carries the SOR related information, and the message may not include information used for selecting a higher priority network (a list of preferred PLMN/access technology combinations and/or a secured packet), indicating that an operator controlled public land mobile network selector with access technology OPLMN list stored in the USIM of the terminal is not changed (that is, no change of the “Operator Controlled PLMN Selector with Access Technology” list stored in the USIM is needed).
4a: After receiving the foregoing message sent by the AF, the UDM determines whether the terminal is required to obtain a service on the higher priority network (steer the terminal).

If the UDM does not require to change the OPLMN stored in the terminal, and does not require the terminal to perform higher priority PLMN selection (the UE is not required to perform the higher priority PLMN selection), that is, the terminal is not required to obtain the service on the higher priority network (the UE is not required to attempt to obtain service on a higher priority PLMN), or in other words, the terminal is not required to perform the SOR procedure (the UE is not required to perform SOR procedure), the UDM sends the first indication information (or referred to as the no change indication) to the terminal, where the first indication information is used to indicate that there is no need to change the OPLMN list stored in the terminal and is used to indicate that no list of preferred PLMN/access technology combinations is provided (no change of the “Operator Controlled PLMN Selector with Access Technology” list stored in the UE is needed and thus no list of preferred PLMN/access technology combinations is provided).

If the UDM is not required to change the OPLMN stored in the terminal, but the terminal is required to perform higher priority PLMN selection, that is, the terminal is required to obtain the service on the higher priority network, or in other words, the terminal is required to perform the SOR procedure, the UDM provides information used for selecting the higher priority network to the AMF or the terminal (namely, a list of preferred PLMN/access technology combinations, and/or, a secured packet (list of preferred PLMN/access technology combinations, and/or, secured packet)), for example, the stored information that is used for selecting the higher priority network and that is sent to the AMF or the terminal last time (for example, a preferred PLMN list: a VPLMN 3 and a VPLMN 2). Optionally, the UDM stores the information that is used for selecting the higher priority network and that is sent to the AMF or the terminal.
5: The UDM sends the SOR information to the AMF, where in a case that the UDM determines that the terminal is not required to obtain the service on the higher priority network, the SOR information sent by the UDM includes the no change indication; or in a case that the UDM determines that the terminal is required to obtain the service on the higher priority network, the SOR information sent by the UDM includes the information used for selecting the higher priority network, for example, the information carries “list of preferred PLMN/access technology combinations, and/or, secured packet”.
6: The UE receives the SOR information from the AMF, where the SOR information carries the information used for selecting the higher priority network, or carries the no change indication.
7: If the terminal receives the no change indication, the terminal:
(1) does not perform the SOR procedure;
(2) does not perform a SOR-CMCI procedure;
(3) does not release a connection (do not release the current N1 NAS signaling connection);
(4) does not attempt to obtain the service on the higher priority network; and
(5) if the UDM does not require an ACK (if the UDM has not requested an acknowledgement from the UE), the terminal does not feed back the ACK (acknowledgement) to the AMF; the AMF does not forward the ACK to the UDM; and the UDM does not forward the ACK to the AF; or
if the terminal receives the information used for selecting the higher priority network (list of preferred PLMN/access technology combinations, and/or, secured packet), the terminal:
(1) releases a link;
(2) attempts to obtain the service on the higher priority network;
(3) if the SOR-CMCI is carried, deregisters from a registered network, and attempts to obtain the service on the higher priority network; and
(4) determines whether the information is the same as the information that is used for selecting the higher priority network and that is received last time, and if the information is the same as the information that is used for selecting the higher priority network and that is received last time, the information is not stored into the OPLMN list of the terminal, or if the information is different from the information that is used for selecting the higher priority network and that is received last time, the information is stored into the OPLMN list of the terminal.

### Embodiment 2

FIG. 6b is a second schematic diagram of a scenario of a network communication method according to an embodiment of this application. As shown in FIG. 6b, the method includes the following steps:
0: A terminal (UE) stores an OPLMN list: a VPLMN 3 and a VPLMN 2.
1: The terminal initiates a registration request to an AMF.
2: The AMF requests SOR related information from UDM based on the registration request.
3: The UDM requests the SOR related information from an AF.
3a: The AF stores OPLMN information, for example, preferably, a preferred PLMN list: the VPLMN 3 and the VPLMN 2.
4: The AF sends a message to the UDM, where the message carries the SOR related information, and if the message does not include information used for selecting a higher priority network, it indicates that the OPLMN list stored in the USIM of the terminal does not change (that is, no change of the “Operator Controlled PLMN Selector with Access Technology” list stored in the USIM is needed).

If the AF is not required to change the OPLMN stored in the terminal, and the terminal is not required to obtain a service on the higher priority network, a steering container is not provided to the UDM. To be specific, the SOR information provided to the terminal does not include the information used for selecting the higher priority network (list of preferred PLMN/access technology combinations, and/or, secured packet).

If the AF finds that the terminal is required to obtain the service on the higher priority network, but there is no need to change the OPLMN stored in the terminal, the SOR information provided to the UDM carries the information used for selecting the higher priority network, for example, preferred PLMN information sent to the terminal last time.

The UDM determines to send the SOR information to the terminal.
5: The UDM sends the SOR information to the AMF.
6: The AMF sends the SOR information to the terminal.
7: The terminal receives and processes the SOR information. Refer to step 7 in the foregoing Embodiment 1 for details. Details are not described herein again.

### Embodiment 3

FIG. 6c is a third schematic diagram of a scenario of a network communication method according to an embodiment of this application. As shown in FIG. 6c, the method includes the following steps:
0: A terminal (UE) stores an OPLMN list: a VPLMN 3 and a VPLMN 2.
1: The terminal initiates a registration request to an AMF.
2: The AMF requests SOR related information from UDM based on the registration request.
3: The UDM requests the SOR related information from an AF.
3a: The AF stores OPLMN information, for example, preferably, a preferred PLMN list: the VPLMN 3 and the VPLMN 2.
4: The AF sends a message to the UDM, where the message carries the SOR related information, and the information may not include information used for selecting a higher priority network.
4a: The UDM receives the SOR related information sent by the AF, and if the UDM finds that there is a need to steer the terminal, the UDM sends a steer identifier to the terminal for indicating whether the terminal is required to obtain a service on the higher priority network, and a no change indication is carried at the same time.
5: The UDM sends a message to the AMF, where the message carries the steer identifier and the no change indication.
6: The AMF sends a message to the terminal, where the message carries the steer identifier and the no change indication.
7: A: The terminal receives the no change indication, and finds, at the same time, that the steer identifier indicates that the terminal is required to obtain the service on the higher priority network, the terminal:
(1) deletes PLMNs indicated by the preferred PLMN/access technology combinations from a forbidden PLMN list and from a list of forbidden PLMNs for general packet radio service (GPRS) service in a case that the PLMNs identified by the list of preferred PLMN/access technology combinations are present in the forbidden PLMN list and the list of forbidden PLMNs for general packet radio service (GPRS) service (delete the PLMNs identified by the list of preferred PLMN/access technology combinations from the Forbidden PLMN list and from the Forbidden PLMNs for GPRS service list, if they are present in these lists);
(2) if SOR-CMCI exists, a SOR-CMCI procedure is performed;
(3) deregisters from a registered network (De-Registration);
(4) releases a NAS signaling connection (release the current N1 NAS signaling connection); and
(5) attempts to obtain the service on the higher priority network; and

B: If the terminal receives the no change indication, and finds, at the same time, that the steer identifier indicates that the terminal is not required to obtain the service on the higher priority network, the terminal:
(1) does not perform the SOR procedure;
(2) does not perform a SOR-CMCI procedure;
(3) does not release a NAS signaling connection (do not release the current N1 NAS signaling connection);
(4) does not attempt to obtain the service on the higher priority network; and
(5) if the UDM does not require an ACK, the terminal does not feed back the ACK to the AMF; the AMF does not forward the ACK to the UDM; and the UDM does not forward the ACK to the AF.

Optionally, in this embodiment, one or several bits may be used in a SOR transparent container to indicate that the terminal is required to perform SOR, or that the terminal is not required to perform SOR. As shown below, the STEER indication may be added to the SOR header:

| 8 | 7 | 6 | 5 | 4 | 3 | 2 | 1 |
|---|---|---|---|---|---|---|---|
| 0 | 0 | STEER | AP | ACK | List | List | SOR data |
| Spare | Spare | indication | | | type | indication | type |

The STEER indication is 0 or 1, where 0 represents that the terminal is not required to perform the SOR procedure, and 1 represents that the terminal is required to perform the SOR procedure. Alternatively, the STEER indication is 0 or 1. When the STEER indication is 0 and the list indication List indication is 0, it indicates that the terminal is not required to perform the SOR procedure; and when the STEER indication is 1 and the list indication List indication is 0, it indicates that the terminal is required to perform the SOR procedure.

It should be noted that, when the List indication is 0, it indicates an HPLMN indication that there is no need to change the OPLMN list stored in the terminal and that no list of preferred PLMN/access technology combinations is provided (HPLMN indication that no change of the “Operator Controlled PLMN Selector with Access Technology” list stored in the UE is needed and thus no list of preferred PLMN/access technology combinations is provided).

### Embodiment 4

FIG. 6d is a fourth schematic diagram of a scenario of a network communication method according to an embodiment of this application. As shown in FIG. 6d, the method includes the following steps:
0: A terminal (UE) stores an OPLMN list: a VPLMN 3 and a VPLMN 2.
1: The terminal initiates a registration request to an AMF.
2: The AMF requests SOR related information from UDM.
3: The UDM requests the SOR related information from an AF by using an interface Nsoraf_SteeringOfRoaming (Nsoraf_SOR) GET request.

The UDM may first determine whether there is a need to steer the terminal, and if there is a need to steer the terminal, the UDM requests the SOR related information from the AF by using the interface Nsoraf_SteeringOfRoaming (Nsoraf_SOR) GET request, where an OPLMN indication identifier is carried, and the OPLMN indication identifier indicates that the AF is required to provide an OPLMN.
3a: After receiving the request from the interface Nsoraf_SteeringOfRoaming (Nsoraf_SOR) GET request, the AF provides the SOR information to the UDM. Optionally, the AF may determine, based on the following information, whether to feed back the OPLMN:
(1) time information, which may mean duration between a current time and a moment at which the OPLMN is sent to the terminal last time; for example, if the AF finds that duration between the current time and the time at which the OPLMN is sent last time reaches a standard, for example, exceeds a value, and the UE is currently located in a VPLMN, the AF feeds back the OPLMN to the UDM, regardless of whether the OPLMN changes compared with the OPLMN stored in the terminal;
(2) position information, for example, a cell identity (CELL ID), a TAI, a satellite identity, geographical position information such as longitude, latitude, and altitude, or the like; optionally, if the AF finds that a current position changes with respect to a position when the OPLMN is sent last time, for example, exceeds an area, and the UE is currently located in a VPLMN, the AF feeds back the OPLMN to the UDM, regardless of whether the OPLMN changes compared with the OPLMN stored in the terminal; and
(3) an INDICATION, indicating whether the SOA-AF must feed back the OPLMN; for example, if the AF finds that the UDM requires the AF to mandatorily feed back the OPLMN, the AF feeds back the OPLMN to the UDM, regardless of whether the OPLMN changes compared with the OPLMN stored in the terminal; and otherwise, the AF determines whether to provide the OPLMN to the UDM.

After receiving the OPLMN indication identifier sent by the UDM, the AF determines, according to the OPLMN indication identifier provided by the UDM, whether to provide the OPLMN to the UDM.

If the identifier indicates that the AF is required to provide the OPLMN, the AF carries the OPLMN in step 4, even if the OPLMN does not change compared with the OPLMN information stored in the UE.

If the identifier indicates that the AF does not mandatorily provide the OPLMN, the AF determines, on its own in step 4, whether to carry the OPLMN. For example, if the OPLMN does not change compared with the OPLMN information stored in the UE, the OPLMN is not carried.
4: The AF provides the SOR information (carrying the OPLMN) to the UDM by using an interface Nsoraf_SteeringOfRoaming (Nsoraf_SOR) GET response.
5: The UDM provides the SOR information to the AMF by using an interface Nudm_SDM_Notification after receiving the SOR information by using the interface Nsoraf_SteeringOfRoaming (Nsoraf_SOR) GET response.
6: The AMF provides the SOR information by using a DL NAS TRANSPORT message.
7: The terminal receives and processes the SOR information. Refer to step 7 in the foregoing Embodiment 1 for details. Details are not described herein again.

### Embodiment 5

FIG. 6e is a fifth schematic diagram of a scenario of a network communication method according to an embodiment of this application. After a terminal is successfully registered, UDM may query an AF for SOR information, and provide found SOR information to an AMF, to further trigger a DL NAS TRANSPORT process of the AMF, and provide the SOR information to UE. As shown in FIG. 6e, the method includes the following steps:
0a: After the terminal has been successfully registered with a VPLMN, when the UDM finds that there is a need to steer the terminal, for example, after a period of time has elapsed or a position of the terminal changes, for example, a cell changes or satellite information changes, the UDM query the AF for latest SOR information.
0b: After receiving the query information of the UDM, the AF sends the SOR information to the UDM by using an interface Nsoraf_SoR_Get response.
1: After receiving the SOR information from the interface Nsoraf_SoR_Get response, the UDM sends the SOR information to the AMF by using an Nudm_SDM_Notification interface; and if the UDM does not receive, within a time, the Nsoraf_SoR_Get response of the AF, the UDM may:
(a) resend the 0a message; or
(b) stop the process, consider that an abnormality occurs, skip subsequently steps 1 to 6, and perform a deregistration operation on the terminal.
2: The AMF sends a downlink non-access stratum transport DL NAS TRANSPORT message to the terminal, where the message includes the SOR information received from the UDM.
3: The terminal performs security check based on the SOR information.
4: The terminal sends an uplink UL NAS TRANSPORT message to the AMF.
5: The AMF feeds back a message to the UDM by using an Nudm_SDM_Info request interface.
6: The UDM feeds back a message to the AF by using an Nudm_SoR_Info request interface, and refer to related protocols for details of the foregoing steps 3 to 6.

It should be noted that, after successful registration, if network transmission carries the SOR-CMCI and the “no change indication” (refer to the descriptions in the foregoing embodiments for specific definitions), the SOR procedure is also triggered.

Optionally, when the terminal receives the DL NAS TRANSPORT message, where the message carries the SOR-CMCI and the “no change indication”, the terminal performs security check. If security check succeeds, the terminal performs at least one of the following by using the SOR information received this time or the stored SOR information:
performing the SOR procedure;
performing a SOR-CMCI procedure;
performing a deregistration procedure;
releasing a connection; and
attempting to obtain a service on a higher priority network (attempt to obtain service on a higher priority PLMN).

It should be noted that the network communication method provided in the embodiments of this application may be performed by a network communication apparatus or a control module that is in the network communication apparatus and that is configured to perform the network communication method. In the embodiments of this application, the network communication apparatus provided in the embodiments of this application is described by using an example in which the network communication apparatus performs the network communication method.

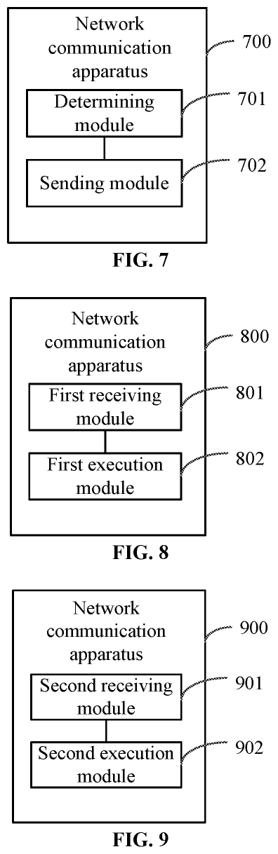

FIG. 7 is a structural diagram of a network communication apparatus according to an embodiment of this application. As shown in FIG. 7, the network communication apparatus 700 includes:
a determining module 701, configured to determine, based on state information, that a terminal is required to obtain a service on a higher priority network, where the state information reflects a service state of the terminal in a selected network, and a priority of the higher priority network is higher than a priority of the selected network; and
a sending module 702, configured to send, to the terminal, at least one of: first indication information and network information, where the first indication information is used to indicate the terminal to attempt to obtain the service on the higher priority network, and the network information is information about the higher priority network.

Optionally, the determining module is further configured to:
determine that an operator controlled public land mobile network OPLMN list stored in the terminal does not need to be changed, and determine, based on the state information, that the terminal is required to obtain the service on the higher priority network.

Optionally, the apparatus is a UDM network element, and the determining module 701 is further configured to:
in response to that SOR information that is of the terminal and that is received from an application function AF network element does not include the network information, determine that the OPLMN list stored in the terminal does not need to be changed, and determine, based on the state information, that the terminal is required to obtain the service on the higher priority network.

Optionally, the apparatus is a UDM network element, and the apparatus further includes:
a receiving module, configured to receive second indication information from an AF network element, where the second indication information is used to indicate no change of the OPLMN list stored in the terminal.

Optionally, the apparatus is a UDM network element, and the sending module 702 is further configured to:
send a first request to an AF network element, where the first request includes third indication information, and the third indication information is used to indicate the AF network element to send the network information to the apparatus.

Optionally, the first request is a SOR information query request.

Optionally, the apparatus is a UDM network element, and the sending module 702 is further configured to:

send, to the terminal, the network information stored by the apparatus.

Optionally, the sending module is further configured to:

send, to the terminal, stored network information that is sent to the terminal last time.

Optionally, the sending module 702 is further configured to:
determine based on the state information, that the terminal is not required to obtain the service on the higher priority network, and send the second indication information to the terminal, where the second indication information is used to indicate no change of the OPLMN list stored in the terminal.

Optionally, the apparatus is the UDM network element, and the sending module 702 is further configured to:
determine, based on the state information, that the terminal is not required to obtain the service on the higher priority network, and send fourth indication information to the AF network element, where the fourth indication information is used to indicate that the network information is not mandatorily provided.

Optionally, the apparatus is an AF network element, and the apparatus is further configured to:
receive the state information from the UDM network element.

Optionally, the apparatus is the AF network element, and the apparatus is further configured to:
receive fourth indication information from the UDM network element, where the fourth indication information is used to indicate that the network information is not mandatorily provided.

Optionally, the sending module 702 is further configured to:
send a first message to the terminal, where the first message includes SOR information, and the SOR information includes the first indication information.

Optionally, the SOR information includes a SOR header, and the SOR header includes the first indication information.

Optionally, the first indication information is carried in a list indication List indication field and/or a STEER indication field of the SOR header.

Optionally, the network information includes at least one of the following:
a list of preferred PLMN/access technology combinations; and
a secured packet.

Optionally, the state information includes at least one of the following: time information, position change information, and subscription information, where
the time information is reflected in a time of service of the terminal in the selected network;
the position information is reflected in a position change of the terminal in the selected network; and
the subscription information is reflected in a change of network subscription information of a network accessed by the terminal.

Optionally, the time information is duration between a current time and a moment at which the apparatus sends the network information to the terminal last time.

Optionally, the position information includes current position information of the terminal and position information of the terminal when the apparatus sends the network information last time.

Optionally, the subscription information is access and mobility subscription data.

The apparatus provided in this embodiment of this application can trigger, based on the service state of the terminal in the selected network, the terminal to perform the SOR procedure, so that the terminal can attempt to obtain the service on the higher priority network. This also enables the terminal to select a network more flexibly and ensures that the terminal can obtain better network services.

The apparatus provided in this embodiment of this application can implement the processes implemented in the method embodiments in FIG. 1 to FIG. 3, with same technical effect achieved. To avoid repetition, details are not described herein again.

FIG. 8 is a structural diagram of another network communication apparatus according to an embodiment of this application. As shown in FIG. 8, the network communication apparatus 800 includes:
a first receiving module 801, configured to receive at least one of: first indication information and network information sent by a first network element, where the first indication information is used to indicate to obtain a service on a higher priority network, the network information is information about the higher priority network, and a priority of the higher priority network is higher than a priority of a selected network; and
a first execution module 802, configured to attempt to obtain the service on the higher priority network based on at least one of: the first indication information and the network information.

Optionally, the first receiving module 801 is further configured to:
receive a first message sent by the first network element, where the first message includes SOR information, and the SOR information includes the first indication information.

Optionally, the SOR information includes a SOR header, and the SOR header includes the first indication information.

Optionally, the first indication information is carried in a list indication List indication field and/or a STEER indication field of the SOR header.

Optionally, the first receiving module 801 is further configured to:
receive second indication information sent by the first network element, where the second indication information is used to indicate no change of an OPLMN list stored in the terminal.

Optionally, the first execution module 802 is further configured to:
perform a SOR procedure.

Optionally, the network information includes at least one of the following:
a list of preferred PLMN/access technology combinations; and
a secured packet.

In this embodiment of this application, the apparatus can obtain, based on the first indication information and/or the network information sent by the first network element, the service on the higher priority network. This also enables the apparatus to select a network more flexibly and ensures that the apparatus can obtain better network services.

The network communication apparatus 800 in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include, but is not limited to, a type of the terminal 11 listed above. The non-mobile terminal may be a server, a network attached storage (NAS), a personal computer (PC), a television (TV), a teller machine, or a self-service machine. This is not specifically limited in this embodiment of this application.

The apparatus provided in this embodiment of this application can implement the processes implemented in the method embodiment of FIG. 4 and achieve same technical effect. To avoid repetition, details are not described herein again.

FIG. 9 is a structural diagram of another network communication apparatus according to an embodiment of this application. As shown in FIG. 9, the network communication apparatus 900 includes:
a second receiving module 901, configured to receive second indication information sent by a first network element, where the second indication information is used to indicate no change of an OPLMN list stored in the apparatus; and
a second execution module 902, configured to perform, based on the second indication information, at least one of the following:
in a case that a UDM network element does not require to obtain an acknowledgement ACK from the apparatus, skipping sending a registration complete message to an AMF network element, where a SOR transparent container of the registration complete message carries the ACK; and
after an N1 NAS signaling connection is released, attempting or skipping attempting to obtain a service on a higher priority PLMN.

In this embodiment of this application, the apparatus can flexibly perform the SOR procedure, and attempt to obtain the service on the higher priority network, to ensure that the apparatus can obtain better network services.

The network communication apparatus 900 in this embodiment of this application may be an apparatus or an apparatus or electronic device with an operating system, or may be a component, an integrated circuit, or a chip in a terminal. The apparatus or electronic device may be a mobile terminal, or a non-mobile terminal. For example, the mobile terminal may include, but is not limited to, a type of the terminal 11 listed above. The non-mobile terminal may be a server, a network attached storage (NAS), a personal computer (PC), a television (TV), a teller machine, or a self-service machine. This is not specifically limited in this embodiment of this application.

The apparatus provided in this embodiment of this application can implement the processes implemented in the method embodiment of FIG. 5 and achieve same technical effect. To avoid repetition, details are not described herein again.

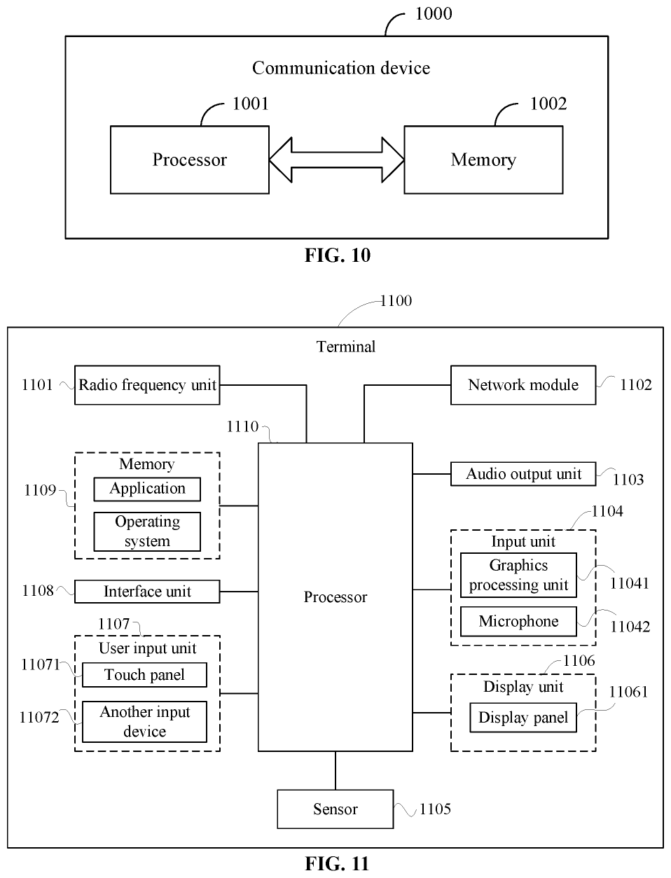

Optionally, as shown in FIG. 10, an embodiment of this application further provides a communication device 1000, including a processor 1001, a memory 1002, and a program or an instruction that is stored in the memory 1002 and that can be run on the processor 1001. For example, in a case that the communication device 1000 is a first network element, when the program or the instruction is executed by the processor 1001, the processes of the foregoing method embodiments in FIG. 1 to FIG. 3 are implemented, with the same technical effects achieved. In a case that the communication device 1000 is a terminal, when the program or the instruction is executed by the processor 1001, the processes of the foregoing method embodiments in FIG. 4 and FIG. 5 are implemented, with the same technical effect achieved. To avoid repetition, details are not described herein again.

An embodiment of this application further provides a terminal, including a processor and a communication interface. This terminal embodiment corresponds to the foregoing method embodiment on the terminal side. Each implementation process and implementation of the foregoing method embodiment may be applicable to this terminal embodiment, and same technical effect can be achieved. Specifically, FIG. 11 is a schematic diagram of a hardware structure of a terminal according to an embodiment of this application.

The terminal 1100 includes but is not limited to at least some components in: a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include a power supply (such as a battery) that supplies power to each component. The power supply may be logically connected to the processor 1110 by using a power management system, to implement functions such as charging and discharging management, and power consumption management by using the power management system. The terminal structure shown in FIG. 11 constitutes no limitation on the terminal, and the terminal may include more or fewer components than those shown in the figure, or combine some components, or have different component arrangements. Details are not described herein.

It should be understood that, in this embodiment of this application, the input unit 1104 may include a graphics processing unit (GPU) 11041 and a microphone 11042, and the graphics processing unit 11041 processes image data of a still image or a video that is obtained by an image capturing apparatus (for example, a camera) in a video capturing mode or an image capturing mode. The display unit 1106 may include a display panel 11061. The display panel 11061 may be configured in a form such as a liquid crystal display or an organic light-emitting diode. The user input unit 1107 includes a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, the radio frequency unit 1101 receives downlink data from a network side device and then sends the downlink data to the processor 1110 for processing; and sends uplink data to the network side device. Usually, the radio frequency unit 1101 includes but is not limited to an antenna, at least one amplifier, a transceiver, a coupler, a low noise amplifier, a duplexer, and the like.

The memory 1109 may be configured to store a software program or an instruction and various data. The memory 1109 may mainly include a program or instruction storage area and a data storage area. The program or the instruction storage area may store an operating system, an application or an instruction required by at least one function (for example, a sound playing function or an image playing function), and the like. In addition, the memory 1109 may include a high-speed random access memory, and may further include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one disk storage device, a flash memory, or another non-volatile solid-state storage device.

The processor 1110 may include one or more processing units. Optionally, an application processor and a modem processor may be integrated into the processor 1110. The application processor mainly processes an operating system, a user interface, an application, an instruction, or the like. The modem processor mainly processes wireless communication, for example, a baseband processor. It may be understood that, alternatively, the modem processor may not be integrated into the processor 1110.

In an implementation, the radio frequency unit 1101 is configured to receive at least one of: first indication information and network information sent by a first network element, where the first indication information is used to indicate to obtain a service on a higher priority network, the network information is information about the higher priority network, and a priority of the higher priority network is higher than a priority of a selected network; and
the processor 1110 is configured to attempt to obtain the service on the higher priority network based on at least one of: the first indication information and the network information.

Optionally, the radio frequency unit 1101 is further configured to:
receive a first message sent by the first network element, where the first message includes SOR information, and the SOR information includes the first indication information.

Optionally, the SOR information includes a SOR header, and the SOR header includes the first indication information.

Optionally, the first indication information is carried in a list indication List indication field and/or a STEER indication field of the SOR header.

Optionally, the radio frequency unit 1101 is further configured to:
receive second indication information sent by the first network element, where the second indication information is used to indicate no change of an OPLMN list stored in the terminal.

Optionally, the processor 1110 is further configured to:
perform a SOR procedure.

Optionally, the network information includes at least one of the following:
a list of preferred PLMN/access technology combinations; and
a secured packet.

In another implementation, the radio frequency unit 1101 is configured to: receive second indication information sent by a first network element, where the second indication information is used to indicate no change of an OPLMN list stored in the terminal; and
the processor 1110 is configured to: configured to perform, based on the second indication information, at least one of the following:
in a case that a UDM network element does not require to obtain an acknowledgement ACK from the terminal, skipping sending a registration complete message to an AMF network element, where a SOR transparent container of the registration complete message carries the ACK; and
after an N1 NAS signaling connection is released, attempting or skipping attempting to obtain a service on a higher priority PLMN.

Based on the solution provided in this embodiment of this application, the terminal 1100 can flexibly perform the SOR procedure, and attempt to obtain the service on the higher priority network, to ensure that the terminal 1100 can obtain better network services.

An embodiment of this application further provides a readable storage medium. The readable storage medium stores a program or an instruction. When the program or the instruction is executed by a processor, the processes of the method embodiment in any one of FIG. 1 to FIG. 5 is implemented, and same technical effect can be achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communication interface, the communication interface is coupled to the processor, and the processor is configured to run a program or an instruction, to implement the processes of the method embodiment in any one of FIG. 1 to FIG. 5, and same technical effect can be achieved. To avoid repetition, details are not described herein again.

It should be understood that the chip mentioned in this embodiment of this application may also be referred to as a system-level chip, a system chip, a chip system, or a system on chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. An element limited by “including a . . . ” does not, without more constraints, preclude the presence of additional identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a better implementation. Based on such an understanding, the technical solutions of this application essentially, or the part contributing to the prior art may be implemented in a form of a computer software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A network communication method, comprising:
determining, by a first network element based on state information, that a terminal is required to obtain a service on a higher priority network, wherein the state information reflects a service state of the terminal in a selected network, and a priority of the higher priority network is higher than a priority of the selected network; and
sending, by the first network element to the terminal, at least one of: first indication information or network information, wherein the first indication information is used to indicate the terminal to attempt to obtain the service on the higher priority network, and the network information is information about the higher priority network.

2. The method according to claim 1, wherein the determining, by a first network element based on state information, that a terminal is required to obtain a service on a higher priority network comprises:
determining, by the first network element, that an operator controlled public land mobile network (OPLMN) list stored in the terminal does not need to be changed, and determining, based on the state information, that the terminal is required to obtain the service on the higher priority network.

3. The method according to claim 2, wherein the first network element is a UDM network element, and the determining, by the first network element, that an OPLMN list stored in the terminal does not need to be changed, and determining, based on the state information, that the terminal is required to obtain the service on the higher priority network comprises:
in response to that SOR information that is of the terminal and that is received from an application function (AF) network element does not comprise the network information, determining, by the UDM network element, that the OPLMN list stored in the terminal does not need to be changed, and determining, based on the state information, that the terminal is required to obtain the service on the higher priority network.

4. The method according to claim 2, wherein the first network element is a UDM network element, and before the determining, by the first network element, that an OPLMN list stored in the terminal does not need to be changed, and determining, based on the state information, that the terminal is required to obtain the service on the higher priority network, the method further comprises:
receiving, by the UDM network element, second indication information from an AF network element, wherein the second indication information is used to indicate no change of the OPLMN list stored in the terminal.

5. The method according to claim 1, wherein the first network element is a UDM network element, and before the sending, by the first network element to the terminal, network information, the method further comprises:
sending, by the UDM network element, a first request to an AF network element, wherein the first request comprises third indication information, and the third indication information is used to indicate the AF network element to send the network information to the UDM network element;
wherein the first request is a SOR information query request.

6. The method according to claim 1, wherein the first network element is a UDM network element, and the sending, by the first network element to the terminal, network information comprises:
sending, by the UDM network element to the terminal, the network information stored by the UDM network element;
wherein the sending, by the UDM network element, the network information stored by the UDM network element to the terminal comprises:
sending, by the UDM network element to the terminal, stored network information that is sent to the terminal last time.

7. The method according to claim 1, wherein the method further comprises:
determining, by the first network element based on the state information, that the terminal is not required to obtain the service on the higher priority network, and sending, by the first network element, the second indication information to the terminal, wherein the second indication information is used to indicate no change of the OPLMN list stored in the terminal.

8. The method according to claim 1, wherein the first network element is the UDM network element, and the method further comprises:
determining, by the UDM network element based on the state information, that the terminal is not required to obtain the service on the higher priority network, and sending fourth indication information to the AF network element, wherein the fourth indication information is used to indicate that the network information is not mandatorily provided.

9. The method according to claim 1, wherein the first network element is an AF network element, and before the determining, by a first network element based on state information, that a terminal is required to obtain a service on a higher priority network, the method further comprises:
receiving, by the AF network element, the state information from the UDM network element;
wherein the first network element is the AF network element, and before the determining, by a first network element based on state information, that a terminal is required to obtain a service on a higher priority network, the method further comprises:
receiving, by the AF network element, fourth indication information from the UDM network element, wherein the fourth indication information is used to indicate that the network information is not mandatorily provided.

10. The method according to claim 1, wherein the sending, by the first network element to the terminal, first indication information comprises:
sending, by the first network element, a first message to the terminal, wherein the first message comprises SOR information, and the SOR information comprises the first indication information;
wherein the SOR information comprises a SOR header, and the SOR header comprises the first indication information;
wherein the first indication information is carried in a list indication List indication field and/or a STEER indication field of the SOR header.

11. The method according to claim 1, wherein the network information comprises at least one of the following:
a list of preferred PLMN/access technology combinations; or
a secured packet.

12. The method according to claim 1, wherein the state information comprises at least one of the following: time information, position change information, or subscription information, wherein
the time information is reflected in a time of service of the terminal in the selected network;
the position change information is reflected in a position change of the terminal in the selected network; and
the subscription information is reflected in a change of network subscription information of a network accessed by the terminal.

13. The method according to claim 12, wherein the time information is duration between a current time and a moment at which the first network element sends the network information to the terminal last time; or,
wherein the position information comprises current position information of the terminal and position information of the terminal when the first network element sends the network information last time; or,
wherein the subscription information is access and mobility subscription data.

14. A network communication method, comprising:
receiving, by a terminal, at least one of: first indication information or network information sent by a first network element, wherein the first indication information is used to indicate to obtain a service on a higher priority network, the network information is information about the higher priority network, and a priority of the higher priority network is higher than a priority of a selected network; and
attempting, by the terminal, to obtain the service on the higher priority network based on at least one of: the first indication information or the network information.

15. The method according to claim 14, wherein the receiving, by a terminal, first indication information sent by a first network element comprises:
receiving, by the terminal, a first message sent by the first network element, wherein the first message comprises SOR information, and the SOR information comprises the first indication information;
wherein the SOR information comprises a SOR header, and the SOR header comprises the first indication information;
wherein the first indication information is carried in a list indication List indication field and/or a STEER indication field of the SOR header.

16. The method according to claim 14, further comprising:
receiving, by the terminal, second indication information sent by the first network element, wherein the second indication information is used to indicate no change of an OPLMN list stored in the terminal.

17. The method according to claim 14, wherein the attempting, by the terminal, to obtain the service on the higher priority network comprises:
performing, by the terminal, a SOR procedure.

18. A network communication method, comprising:
receiving, by a terminal, second indication information sent by a first network element, wherein the second indication information is used to indicate no change of an OPLMN list stored in the terminal; and
performing, by the terminal based on the second indication information, at least one of the following:
in a case that a UDM network element does not require to obtain an acknowledgement ACK from the terminal, skipping sending a registration complete message to an AMF network element, wherein a SOR transparent container of the registration complete message carries the ACK; or
after an N1 NAS signaling connection is released, attempting or skipping attempting to obtain a service on a higher priority PLMN.

19. A network element, wherein the network element is a first network element, and comprises a processor, a memory, and a program or an instruction that is stored in the memory and that can be run on the processor, wherein when the program or the instruction is executed by the processor, the steps of the network communication method according to claim 1 are implemented.

20. A terminal, comprising a processor, a memory, and a program or an instruction that is stored in the memory and that can be run on the processor, wherein when the program or the instruction is executed by the processor, the steps of the network communication method according to claim 14 are implemented.
